(19) United States
(12) Patent Application Publication
(10) Pub. No.: US 2016/0059915 A1
(43) Pub. Date: Mar. 3, 2016

(54) PORTABLE PLATFORM

(71) Applicant: Christopher EATHERINGTON, Houston, TX (US)

(72) Inventor: Christopher EATHERINGTON, Houston, TX (US)

(21) Appl. No.: 14/839,340

(22) Filed: Aug. 28, 2015

Related U.S. Application Data
(60) Provisional application No. 62/044,006, filed on Aug. 29, 2014.

(51) Int. Cl. B62D 63/06

(52) U.S. Cl. CPC B62D 63/061

(57) ABSTRACT

A portable platform includes a trailer having a frame, an undercarriage, a plurality of wheels attached to the undercarriage, and a hitch. A platform is attached to the frame and includes a base segment attached to a top surface of the frame and a plurality of platform segments coupled with the base segment. The plurality of platform segments are configured to transition to be in substantially the same plane as the base segment when in use, and transition until substantially on top of, and substantially flush with, the base segment when in storage thereby decreasing the total exposed surface area.

### FIELD OF TECHNOLOGY

The present disclosure relates generally to portable platforms, and more specifically, to foldable, portable platforms configured to have a use configuration and a stored configuration.

### BACKGROUND

When attending an outdoor location or event, such as a campground facility, sporting or tailgate venues, or a sales forum such as a flea market or bazaar, individuals are generally compelled to utilize the facilities available at that location. Additionally, the facility can be affected by weather conditions. Typical venues are generally limited to concrete surfaces, asphalt surfaces, grass or dirt.

### BRIEF DESCRIPTION OF THE DRAWINGS

In order to describe a manner in which features of the disclosure can be obtained, reference is made to specific embodiments that are illustrated in the appended drawings. The components in the drawings are not necessarily drawn to scale, the emphasis instead being placed upon clearly illustrating the principles of the disclosure. Based on an understanding that these drawings depict only example embodiments of the disclosure and are not intended to be limiting of scope, the principles herein are described and explained with additional specificity and detail through the use of the accompanying drawings. Moreover, in the drawings, like reference numerals designate corresponding parts throughout the several views.

FIG. 1 is an isometric view of an example embodiment of a portable platform in a deployed configuration.

FIG. 2 is an isometric view of a second example embodiment of a portable platform in an undeployed configuration.

FIG. 3 is an isometric view of a second example embodiment of a portable platform in a deployed configuration.

FIG. 4 is an isometric view of a second example embodiment of a portable platform in an undeployed configuration.

FIG. 5 is an isometric view of a third example embodiment of a portable platform in a deployed configuration.

FIG. 6 is an isometric view of a third example embodiment of a portable platform in an undeployed configuration.

FIG. 7 is an isometric view of a fourth example embodiment of a portable platform in a deployed configuration.

FIG. 8 is an isometric view of a fifth example embodiment of a portable platform in a deployed configuration.

FIG. 9 is an isometric view of the fifth example embodiment of a portable platform of FIG. 8, viewed from another perspective.

FIG. 10 is an isometric view of the fifth example embodiment of a portable platform in an undeployed configuration.

FIG. 11 is an isometric view of the fifth example embodiment of the portable platform of FIG. 10, viewed from another perspective.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “substantially” is defined to be essentially conforming to the particular dimension, shape or other word that substantially modifies, such that the component need not be exact. For example, substantially cylindrical means that the object resembles a cylinder, but can have one or more deviations from a true cylinder. The term “comprising” means “including, but not necessarily limited to”; it specifically indicates open-ended inclusion or membership in a so-described combination, group, series and the like.

The present disclosure is described in relation to portable platforms. The portable platforms can be used for sporting events, backyards, hunting, camping, vacations, emergency medical situations, disaster relief, or any other suitable use. The portable platform can be easily transported between locations and quickly transitioned from an undeployed, transportable configuration to a deployed, use configuration.

A deployed configuration can be defined, at least one embodiment, as where a base segment and each platform segment can be aligned in substantially the same plane, such that a top surface of the base segment and a top surface of each platform segment is substantially level with respect to each other segment.

An undeployed configuration can be defined, in at least one embodiment, as where the base segment and each platform segment are stacked substantially on top of another segment. An undeployed configuration can also be defined as where the each platform segment is substantially perpendicular to the base segment. These arrangements can be beneficial for transportation as the portable platform becomes smaller and more aerodynamic.

The platform can be detachably coupled with a trailer. The trailer can include a frame and undercarriage configured to support the platform. In at least one embodiment, the trailer can be a commercial off-the-shelf (COTS) trailer and modified to support the platform. In other embodiments, the trailer can be a custom built trailer designed specifically for use with the portable platform. The trailer can include a hitch configured to detachably couple to a vehicle. The hitch can further include a hitch stand to engage the ground and provide additional stability when the trailer is not detachably coupled with a vehicle. The hitch stand can be in the form of a single beam, a tripod, or any other suitable configuration. The hitch can further include one or more feet located at the bottom of the hitch stand to increase the surface area of engagement between the hitch stand and the ground.

A portable platform can include a base segment and a plurality of platform segments pivotably attached to the base segment and configured to be arranged in a deployed configuration or an undeployed configuration. The base segment can be coupled with the frame. In at least one embodiment, the portable platform includes two platform segments pivotably attached to opposite edges of the base segment. The pivotable attachment can be achieved through the use of a hinge configured to rotate the platform segments from an undeployed configuration to a substantially level deployed configuration.

In at least one embodiment, the pivotable attachment can be a translatable hinge. In another embodiment, the pivotable attachment can be a hinge having multiple axes of rotation. In at least one embodiment, the portable platform includes six platform segments, three pivotably attached at each opposing edge of the base segment and each segment's pivotable edge is equal to substantially one-third the length of the base segment. In this arrangement, the platform segments can employ hinge mechanisms as discussed above.

The plurality of platform segments can alternatively be slidably coupled with the portable platform. In at least one embodiment the base segment and platform segments slidably transition between an undeployed and deployed configuration. In at least one embodiment, the base segment and platform segments employ a tongue and groove system at corresponding edges to securely couple when in a deployed configuration.

In at least one embodiment, the portable platform includes two platform segments and one of the platform segments can be rotated such that the top surface of that platform segment is substantially stacked on to the top surface of the base segment. The other of the two platform segments can include a flushing section configured to allow the top surface of the other platform segment to stack substantially on to the bottom surface of the opposing platform segment. The flushing section being substantially equal to the thickness of the base segment and the opposing platform segment and the flushing section being substantially vertical when the other platform segment is in a folded (undeployed) configuration. The flushing section allows the other platform segment to fold substantially flush. In a similar embodiment, the portable platform can include additional platform segments and each segment can be pivotably mounted along one edge of the base segment includes a flushing section.

In an alternative embodiment, the portable platform can include a plurality of platform segments slidably coupled with the portable platform. The plurality of platform segments can be supported by rails which are configured to move laterally along the width of the base segment from an undeployed configuration to a deployed configuration. After sliding, each platform segment can enter a locked position such that the top surface of the platform segment is substantially level and flush with the base segment. The platform segments can be unlocked through a releasable mechanism and then slidably moved into the undeployed configuration.

In at least one embodiment wherein the platform segments slidably couple to the base segment, an edge of each platform segment can be configured to detachably couple a corresponding edge of the base segment in the deployed configuration. An edge of each platform segment can include an engagement groove along the length of each edge and configured to mate with a receiving groove of the corresponding edge of the base segment. The edges of each platform segment and the base segment can also be configured to receive a locking mechanism along a thickness of the engagement grooves and the receiving grooves to couple the platform segments to the base segment. The locking mechanism can be a threaded screw and a nut, a bolt and a nut, a bolt and a cotter pin, or any other similar locking mechanism.

In at least one embodiment, the portable platform can include a staircase pivotably attached to the base segment. In at least one embodiment, the platform segments can be substantially vertical and therefore perpendicular to the base segment when in an undeployed configuration with a staircase arrangement. In an alternative embodiment, the platform segments can be stacked substantially on top of another segment, and the staircase can be pivotably attached to base segment and rotated such that the top step is substantially flush against the surface of another stacked segment. This embodiment can further include a flushing section as described above.

The portable platform can include a plurality of structural supports configured to expand and retract along the width of the platform. These structural supports can be rib structures designed to support the platform segments when in a deployed configuration. In at least one embodiment, the structural supports can be mounted to the trailer and telescope outward to support the platform segments. In other embodiments the structural supports can be mounted to the platform segments.

In at least one embodiment, the portable platform can include a plurality of structural supports configured to rotatably pivot between an undeployed configuration and a deployed configuration. In an undeployed configuration, the rotatable structural supports can be positioned substantially flush with the base segment. The rotatable structural supports can include a platform segment mounted thereto or a bracket configured to receive a platform segment once in a deployed configuration. In a deployed configuration, the structural supports can be substantially parallel to the top surface of the base segment. The structural supports can be configured to receive a platform segment once deployed. In another embodiment, the structural supports can rotate inwardly toward the middle of the portable platform and be configured to receive a platform segment when in a deployed configuration. The plurality of structural supports can include a locking mechanism to secure them in a deployed configuration.

The portable platform can also include a plurality of detachably coupled leveling supports configured to contact the ground and support the platform segments. The leveling supports can be extendable to varying heights to ensure the platform segments are substantially level when in the deployed configuration. Each leveling support can include a foot, located at the bottom the leveling support, which is has a larger diameter than the diameter of the leveling support. The foot can engage the ground and provide stability to the platform segments when in the deployed configuration. The leveling supports can be configured to work in conjunction with the structural supports or in place of the structural supports. The leveling supports can be integrally formed and pivotably coupled onto a bottom surface such that, in the deployed configuration the segments can be configured to be substantially perpendicular to the leveling supports, and substantially parallel to the segments in the undeployed configuration. The integrally formed leveling supports can further be configured to fold substantially flush within the bottom surface of each segment.

In at least one embodiment, each leveling support can include a hydraulic or pneumatic piston assembly for varying the height of the leveling support and be integrally formed into the bottom surface of each platform segment. In other embodiments, each leveling support can be a telescoping tube including a pin assembly to lock the leveling support at a desired height.

The portable platform can include at least one mounting point. The at least one mounting point can be configured to support a post. The post can be configured to support a covering. The covering can be a canopy assembly, an awning, an umbrella, or meshed netting. In at least one embodiment, the portable platform includes four mounting points supporting four posts. Each of the four posts can support a corner of a covering. In at least one embodiment, the covering can further include a downwardly deployable bug netting (fine mesh) configured to be stored within the covering when not in use. In another embodiment, the portable platform can include one or more mounting points supporting one post holding a cantilever covering.

The portable platform can also include an electrical system. The electrical system can be configured to support lighting, air conditioning, fans, televisions, electrical power, or any other electrical system. In at least one embodiment, the electrical system can be configured to be self-contained in generating (for example, by a gas-powered generator) and distributing electrical power. In at least one embodiment, the electrical system can be configured to draw power from standard RV connections at campgrounds, tailgates, or the like. In at least one embodiment, the lighting system can be an LED lighting system capable of displaying a plurality of colors determined by a user.

The portable platform can also include a propane or natural gas system, or any other suitable gas system configured to use any other suitable fuel such as gasoline or kerosene. The gas system can be at least one stand gas-grill propane canister mounted to the portable platform and configured to power a grill. The gas system can also be utilized to power air conditioning, a generator, water heater, fire pit, or the like depending on the specific electrical system implemented. In at least one embodiment, the gas system can include one or more standard gas-grill propane tanks mounted to the front portion of the trailer and configured to power a detachably mounted propane grill/smoker.

The portable platform can also include a water system. The water supply system can include a tank integrally formed within the trailer and designed to carry clean water for showering, washing hands, cleaning dishes, supplying a bathroom, or fire suppression. The water supply system can further include a secondary collection tank designed to collect used water. In at least one embodiment, the portable platform can have a 10-, 20-, or 30-gallon, or larger, water tank formed within the frame of the trailer and configured to supply water for cleaning dishes and washing hands. In other embodiments, the water supply system can include connections for hooking up to exterior water connections such as faucets or RV connections at campgrounds, tailgates, or the like.

The base segment and the platform segments can include seating stowably formed within the surface. The seating can include, but is not limited to, chairs and couches configured to deploy and support seating. The seating can be configured to fold substantially flush into the surface of a segment when in an undeployed configuration.

In at least one embodiment, each platform segment can include any combination of the above described features, and each platform segment can be interchangeably attached to the base segment replacing any other platform segment. Each replacement platform segment can include a different combination of features. In at least one embodiment, the base segment can be coupled with two platform segments for a specific purpose, and then have those platform segments decoupled and a different set of platform segments coupled for an alternative purpose.

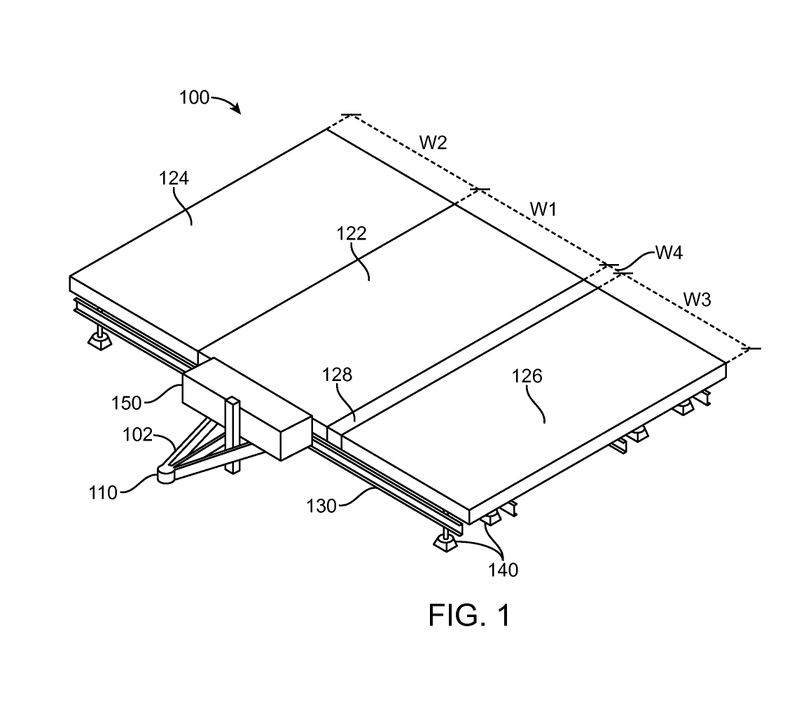

FIG. 1 is an isometric view of an example embodiment of a portable platform 100 in a deployed configuration. The portable platform 100 can include a trailer 102, a base segment 122, a plurality of platform segments 124, 126, and a flushing section 128. The trailer 102 can include a frame and undercarriage configured to support the portable platform 100. The base segment 122 of the platform 100 can be detachably coupled onto the frame of the trailer 102.

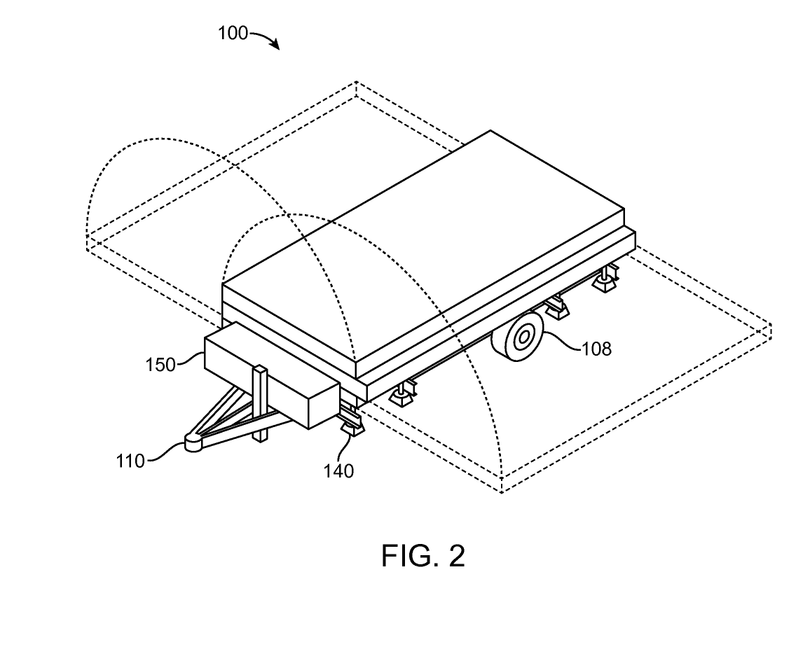

In the illustrated embodiment, the portable platform 100 includes two platform segments 124, 126. Platform segment 124 can be pivoted such that the top surface of platform segment 124 is substantially stacked on to the top surface of the base segment 122. (Shown in FIG. 2). Platform segment 126 includes a flushing section 128 configured to allow the top surface of platform segment 126 to stack substantially on to the bottom surface of the opposing platform segment 124.

As can be appreciated in FIG. 1, the flushing section 128 can be coupled with the base segment 122 and platform segment 126. The width, W2, of platform segment 124 and the width, W3, of platform segment 126 can be substantially equal to or less than the width, W1, of base segment 122. The width, W4, of the flushing section 128 can be substantially equal to the thickness of the base segment 122 and the opposing platform segment 124. The flushing section 128 being substantially vertical when the other platform segments are in a folded (undeployed) configuration, as shown in FIG. 2. The flushing section 128 allows the platform segment 126 to fold substantially flush. In a similar embodiment, the portable platform 100 can include additional platform segments and each segment can be pivotably mounted along one edge of the base segment includes a flushing section. Each platform segment 124, 126 can be split into any number of segments thereby reducing the weight of each individual segment and increasing the ease of deployment.

The trailer can include a hitch 110 configured to detachably couple to a vehicle. The trailer 102 can also include at least two wheels 108 (as shown in FIG. 2). In other embodiments, the trailer 102 can include a plurality of wheels 108, such as a tandem axle having four, six, eight wheels, or any other number of wheels.

In at least one embodiment, the trailer 102 can be a commercial off-the-shelf (COTS) trailer modified to support the platform. In other embodiments, the trailer 102 can be a custom built trailer designed specifically for use with the platform. The portable platform can also include a trailer box 150 coupled with or mounted on portion of the trailer 102 adjacent to the base segment 122.

As further shown in FIG. 1, the portable platform 100 can include a plurality of structural supports 130 configured to expand and retract along the width of the platform. These structural supports 130 can be rib structures designed to support the platform segments 124, 126 when in the deployed configuration. In at least one embodiment, the structural supports 130 can be mounted to the trailer 102 and extend or telescope outward to support the platform segments 124, 126. In other embodiments, the structural supports 130 can be mounted to the platform segments 124, 126 and the flushing section 128.

The portable platform 100 can also include a plurality of detachably coupled leveling supports 140 configured to contact the ground and support the platform segments 124, 126 and the flushing section 128. The leveling supports 140 can be extendable to varying heights to ensure the platform segments 124, 126 and the flushing section 128 are substantially level when in the deployed configuration. The leveling supports 140 can be designed to work in conjunction with the structural supports 130 or in place of the structural supports 130. Each leveling support 140 can include a foot, located at the bottom the leveling support 140, which is has a larger diameter than the diameter of the leveling support 140. The foot can engage the ground and provide stability to the platform segments 124, 126 when in the deployed configuration. The leveling supports 140 can be integrally formed and pivotably coupled onto bottom surfaces of the platform segments 124, 126 and the flushing section 128 such that, in the deployed configuration the segments 124, 126 can be configured to be substantially perpendicular to the leveling supports 140, and substantially parallel to the segments 124, 126 in the undeployed configuration. The integrally formed leveling supports 140 can further be configured to fold substantially flush within the bottom surface of each segment.

In at least one embodiment, the leveling supports 140 can have piston assemblies and can be integrally formed into the bottom surface of each platform segment. In other embodiments, the leveling supports 140 can be telescoping tubes having a pin assembly to lock the leveling supports 140 into a desired height.

FIG. 2 is an isometric view of an example embodiment of the portable platform 100 in an undeployed configuration and showing lines of motion when converting the portable platform 100 from the deployed configuration and the undeployed configuration.

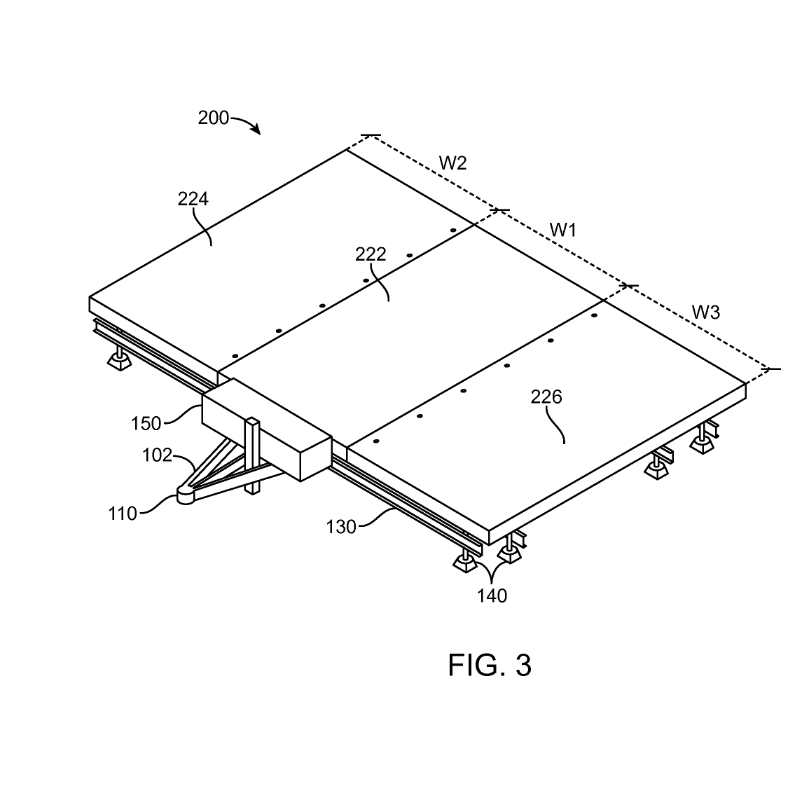

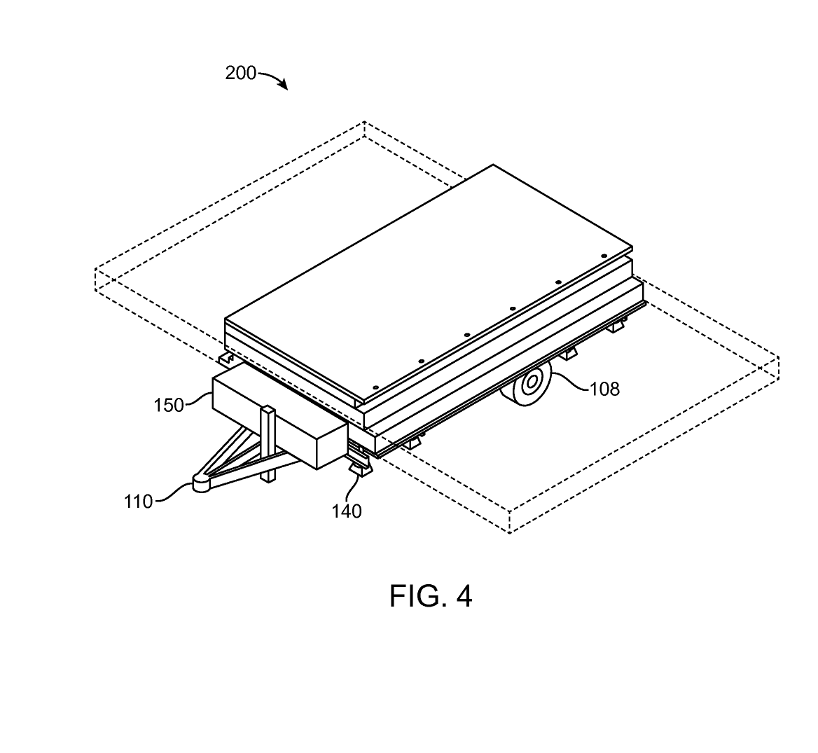

FIG. 3 is an isometric view of second example embodiment of a portable platform 200 in a deployed configuration. The portable platform 200 can include a trailer 102 and a platform comprising a base segment 222, and a plurality of platform segments 224, 226. The trailer 102 can include a frame and undercarriage configured to support the platform. The base segment 222 of the platform can be coupled with or mounted on the frame of the trailer 102. The portable platform 200 can include two platform segments 224, 226. An edge of each platform segment 224, 226 can be configured to detachably couple a corresponding edge of the base segment 222 in the deployed configuration. An edge of each platform segment 224, 226 can include an engagement groove along the length of each edge and configured to mate with a receiving groove of the corresponding edge of the base segment 222. (Shown in FIG. 4). The edges of each platform segment 224, 226 and the base segment 222 can also be configured to receive a locking mechanism along a thickness of the engagement grooves and the receiving grooves to couple the platform segments 224, 226 to the base segment 222. The locking mechanism can be a threaded screw and a nut, a bolt and a nut, a bolt and a cotter pin, or any other similar locking mechanism.

As can be appreciated in FIG. 3, the width, W2, of platform segment 224 and the width, W3, of platform segment 226 can be substantially equal to or less than the width, W1, of base segment 222.

The trailer 102 can include a hitch 110 configured to detachably connect to a vehicle. The trailer 102 can also include at least two wheels 108 (as shown in FIG. 4). In other embodiments, the trailer 102 can include a plurality of wheels 108, such as a tandem axle having four or eight wheels. The portable platform 200 can also include a trailer box 150 coupled with or mounted on a portion of the trailer 102 adjacent to the base segment 222.

As can further be appreciated in FIG. 3, the portable platform 200 can include a plurality of structural supports 130 configured to expand and retract along the width of the platform 200. These structural supports 130 can be rib structures designed to support the platform segments 224, 226 when in the deployed configuration. In at least one embodiment, the structural supports 130 can be mounted to the trailer 102 and telescope outward to support the platform segments 224, 226. In other embodiments the structural supports 130 can be mounted to the platform segments 224, 226.

The portable platform 100 can also include a plurality of detachably coupled leveling supports 140 configured to contact the ground and support the platform segments 224, 226. The leveling supports 140 can be extendable to varying heights to ensure the platform segments 224, 226 are substantially level when in the deployed configuration. Each leveling support 140 can include a foot, located at the bottom the leveling support 140, which is has a larger diameter than the diameter of the leveling support 140. Each foot can engage the ground and provide stability to the platform segments 224, 226 when in the deployed configuration. The leveling supports 140 can be designed to work in conjunction with the structural supports 130 or in place of the structural supports 130. The leveling supports 140 can be integrally formed and pivotably coupled onto bottom surfaces of the platform segments 224, 226 such that, in the deployed configuration the segments 224, 226 can be configured to be substantially perpendicular to the leveling supports 140, and substantially parallel to the segments 224, 226 in the undeployed configuration. The integrally formed leveling supports 140 can further be configured to fold substantially flush within the bottom surface of each segment 224, 226.

In at least one embodiment, the leveling supports 140 can have piston assemblies and can be integrally formed into the bottom surface of each platform segment 224, 226. In other embodiments, the leveling supports 140 can be telescoping tubes having a pin assembly to lock the leveling supports 140 into a desired height.

FIG. 4 is an isometric view of a second example embodiment of a portable platform 200 in an undeployed configuration. The edge of each platform segment 224, 226 can include an engagement groove along the length of each edge and configured to mate with a receiving groove of the corresponding edge of the base segment 222. The edges of each platform segment 224, 226 and the base segment 222 can also be configured to receive a locking mechanism along a thickness of the engagement grooves and the receiving grooves to couple the platform segments 224, 226 to the base segment 222.

The locking mechanism can be a threaded screw and a nut, a bolt and a nut, a bolt and a cotter pin, or any other similar locking mechanism. When transitioning from the deployed configuration to the undeployed configuration, the locking mechanisms can be removed and the platform segments 224, 226 can be pulled away from the base segment 222. The platform segments 224, 226 can then be stacked on the top of the base segment 222 and secured by a securing mechanism for transportation. The securing mechanism can be, for example, one or more adjustable straps or clasps, or any other suitable securing means known to one of ordinary skill in the art.

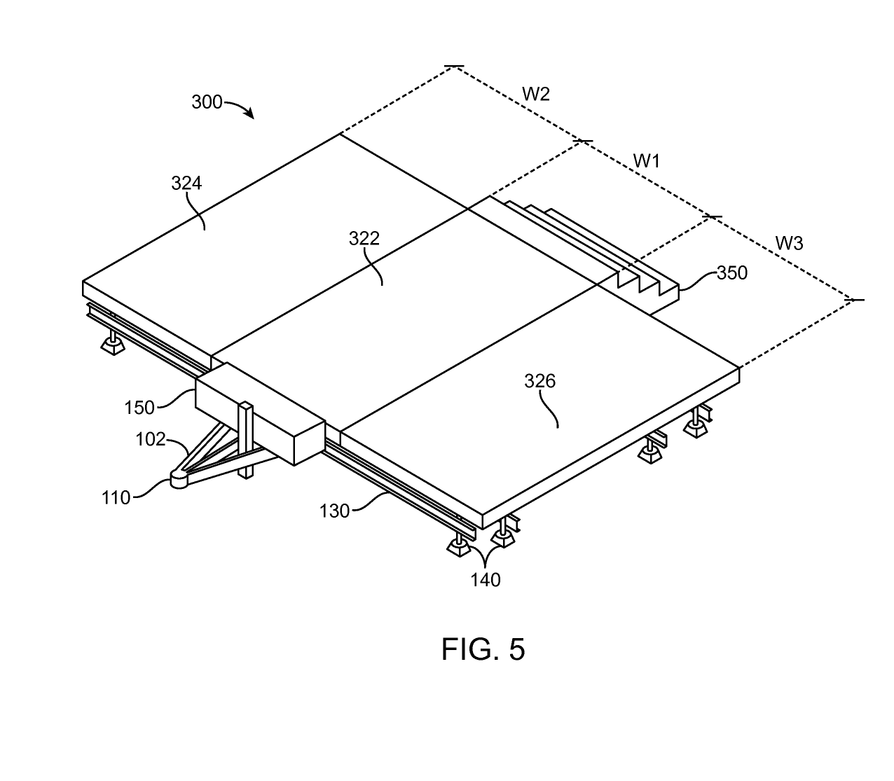

FIG. 5 is an isometric view of third example embodiment of a portable platform 300 in a deployed configuration. The portable platform 300 can include a trailer 102 and a platform comprising a base segment 322 and a plurality of platform segments 324, 326. The trailer 102 can include a frame and undercarriage configured to support the platform. The base segment 322 of the platform 300 can be coupled with or mounted on the frame of the trailer 102. The portable platform 300 can include two platform segments 324, 326 and one of the platform segments can be rotated such that the top surface of that platform segment is substantially stacked on to the top surface of the base segment 322. The other platform segment can be rotated such that the top surface of that platform segment is substantially stacked onto the bottom of the previous platform segment.

As can be appreciated in FIG. 5, the width, W2, of platform segment 324 and the width, W3, of platform segment 326 can be substantially equal to or less than the width, W1, of base segment 322.

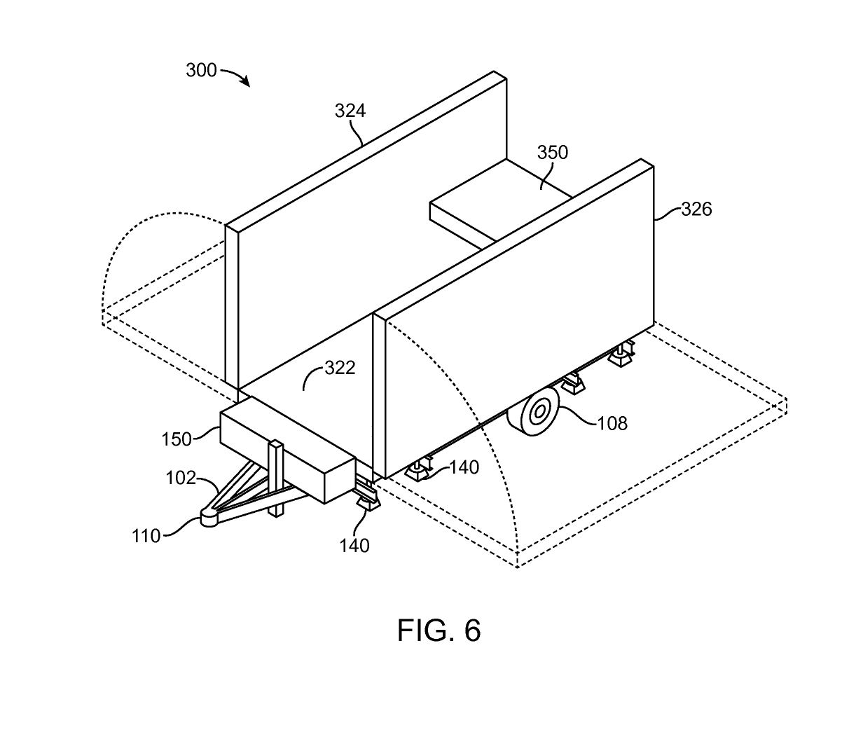

The trailer can include a hitch 110 configured to detachably connect to a vehicle. The trailer 102 can also include at least two wheels 108 (as shown in FIG. 6). In other embodiments, the trailer 102 can include a plurality of wheels 108, such as a tandem axle having four, six, eight wheels, or any other number of wheels. The portable platform 300 can also include a trailer box 150 coupled with or mounted on a portion of the trailer 102 adjacent to the base segment 322. The portable platform 300 can also include a staircase 350 pivotably attached to the base segment 322.

As can further be appreciated in FIG. 5, the portable platform 300 can include a plurality of structural supports 130 configured to expand and retract along the width of the platform. These structural supports 130 can be rib structures designed to support the platform segments when in the deployed configuration. In at least one embodiment, the structural supports 130 can be mounted to the trailer 102 and telescope outward to support the platform segments 324, 326. In other embodiments the structural supports 130 can be mounted to the platform segments 324, 326.

The portable platform 300 can also include a plurality of detachably coupled leveling supports 140 configured to contact the ground and support the platform segments 324, 326. The leveling supports 140 can be extendable to varying heights to ensure the platform segments 324, 326 are substantially level when in the deployed configuration. Each leveling support 140 can include a foot, located at the bottom the leveling support 140, which is has a larger diameter than the diameter of the leveling support 140. The foot can engage the ground and provide stability to the platform segments 324, 326 when in the deployed configuration. The leveling supports 140 can be designed to work in conjunction with the structural supports 130 or in place of the structural supports 130. The leveling supports 140 can be integrally formed and pivotably coupled onto bottom surfaces of the platform segments 324, 326 such that, in the deployed configuration the segments 324, 326 can be configured to be substantially perpendicular to the leveling supports 140, and substantially parallel to the segments 324, 326 in the undeployed configuration. The integrally formed leveling supports 140 can further be configured to fold substantially flush within the bottom surface of each segment 324, 326.

In at least one embodiment, the leveling supports 140 can have piston assemblies and be integrally formed into the bottom surface of each platform segment 324, 326. In other embodiments, the leveling supports 140 can be telescoping tubes having a pin assembly to lock the leveling supports 140 into a desired height.

FIG. 6 is an isometric view of a third example embodiment of a portable platform 300 in the undeployed configuration. As can be appreciated in FIG. 6, the platform segments 324, 326 can be substantially vertical when in an undeployed configuration with the staircase 350 located therebetween. In an alternative embodiment, the platform segments 324, 326 can be configured to be stacked substantially on top of the base segment 322 with the staircase rotated on top of the stacked platform segments 324, 326.

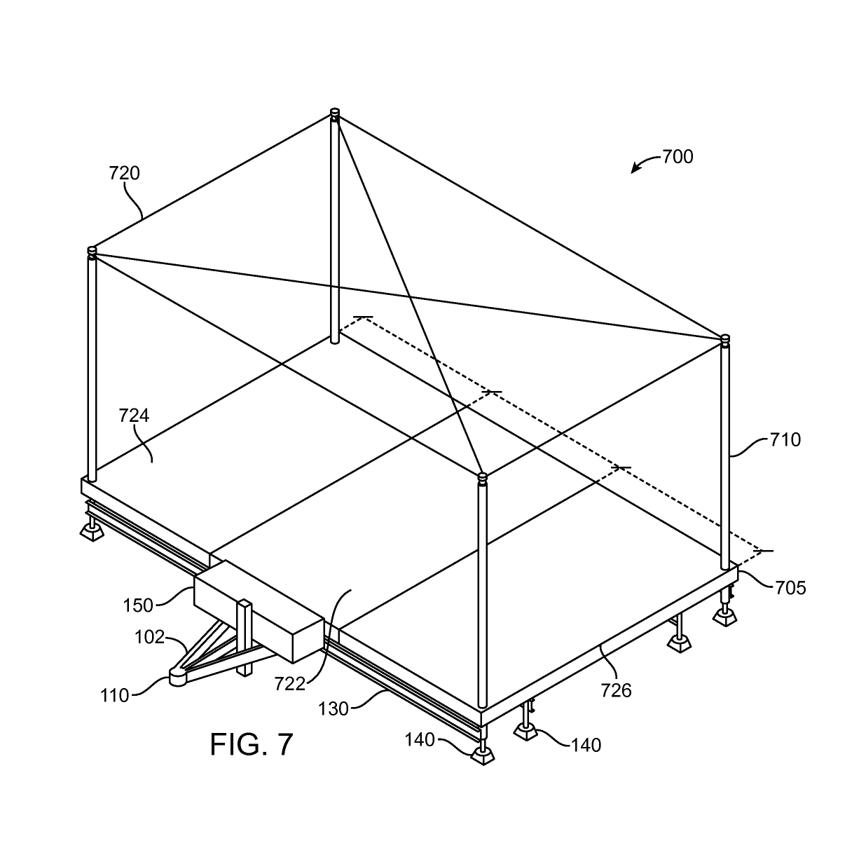

FIG. 7 is an isometric view of a fourth example embodiment of a portable platform 700 in a deployed configuration including a cover frame for a covering. A base segment 722 of the platform 700 can be coupled with or mounted on the frame of the trailer 102. The portable platform 700 can include two platform segments 724, 726 and one of the platform segments can be rotated such that the top surface of that platform segment is substantially stacked on to the top surface of the base segment 722.

In at least one embodiment, the portable platform 700 can include at least four posts 710, one post 710 secured to each corner the portable platform by a mounting point 705 respectively. In at least one embodiment, the cover frame can include at least two support members 720 detachably coupled with diagonally opposed posts 710. In another embodiment, the portable platform 700 can include one mounting point 705 securing one post 710 configured to support a cantilever cover. The cover frame can further include a covering (not shown) positioned on the top of the cover frame. The canopy can be a canopy assembly, an umbrella assembly, meshed netting, or any other suitable covering.

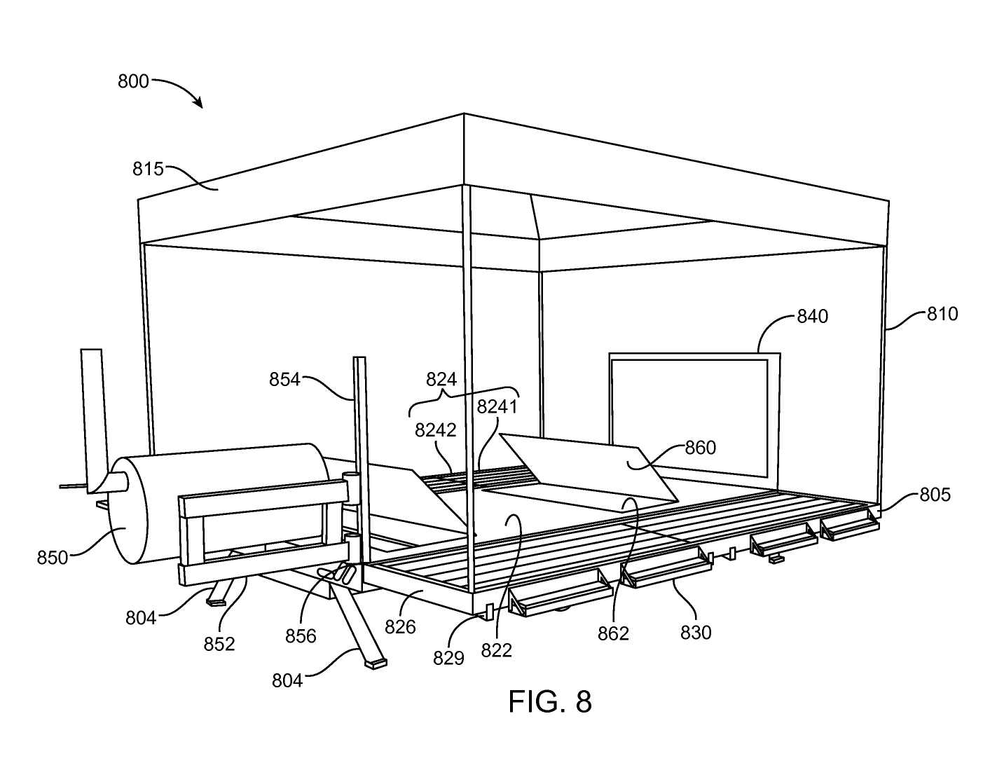

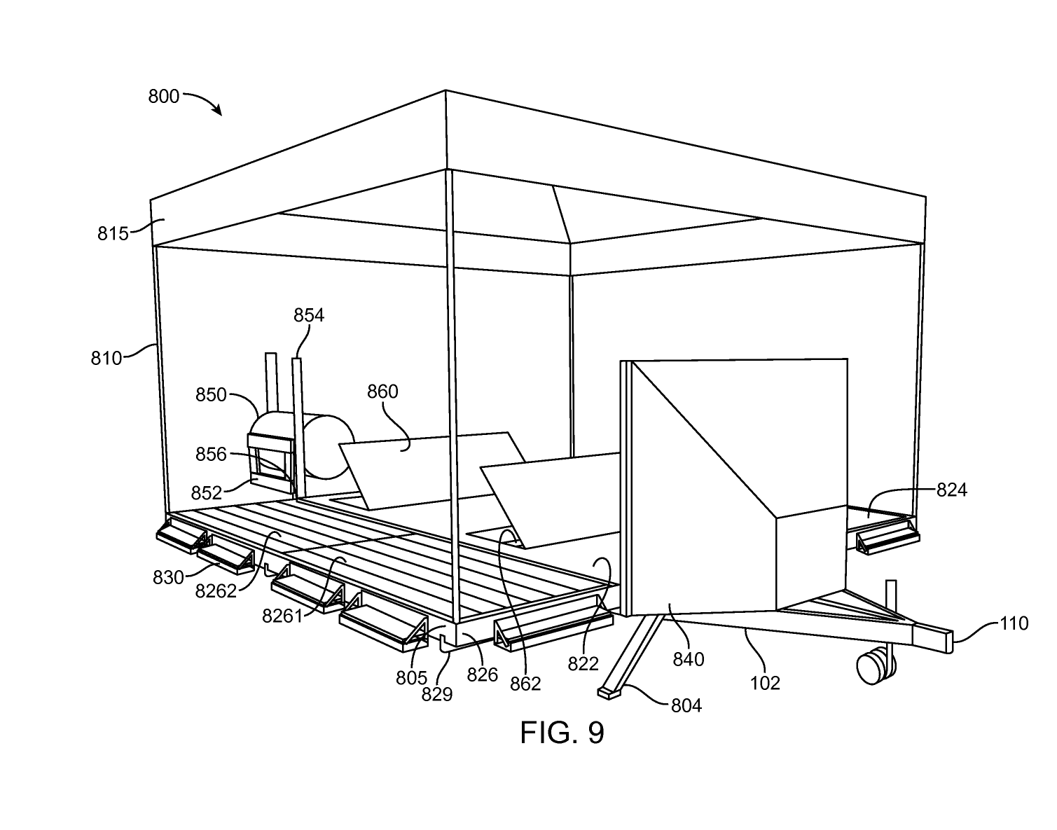

FIG. 8 is an isometric view of a fifth example embodiment of a portable platform 800 in a deployed configuration. FIG. 9 is an isometric view of the fifth example embodiment of a portable platform in a deployed configuration, viewed from another perspective. The portable platform 800 comprises a base segment 822 which can be coupled with or mounted on a frame of the trailer 102. The trailer 102 can have a frame, undercarriage, and hitch 110.

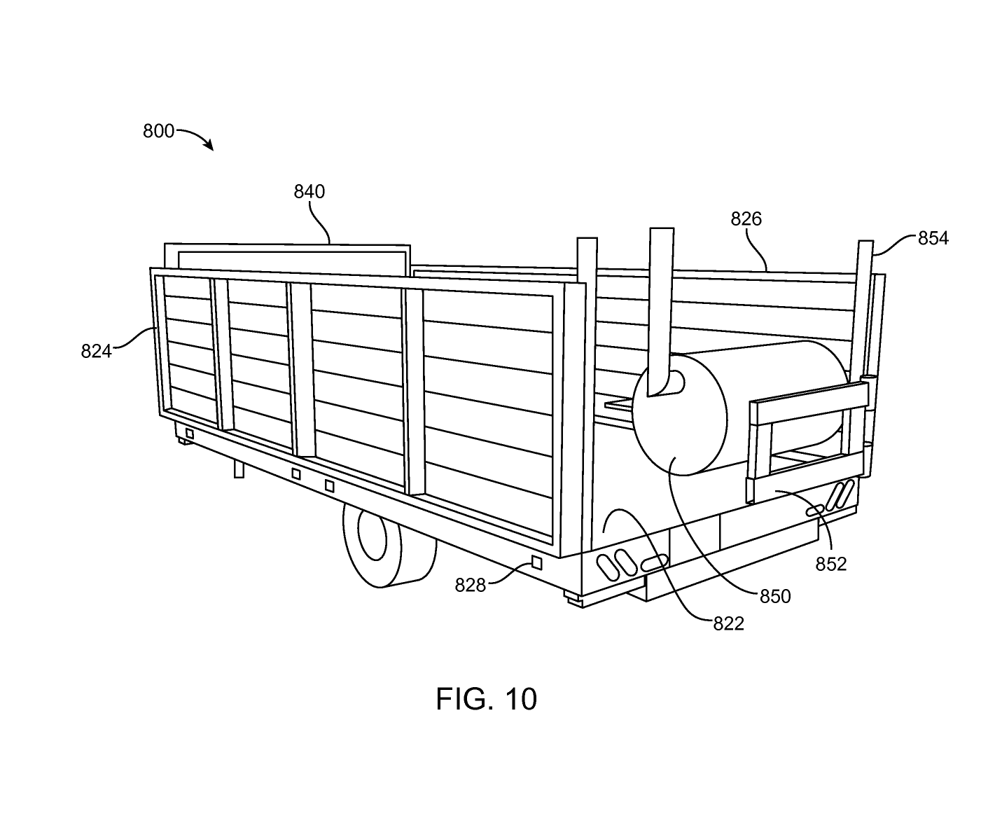

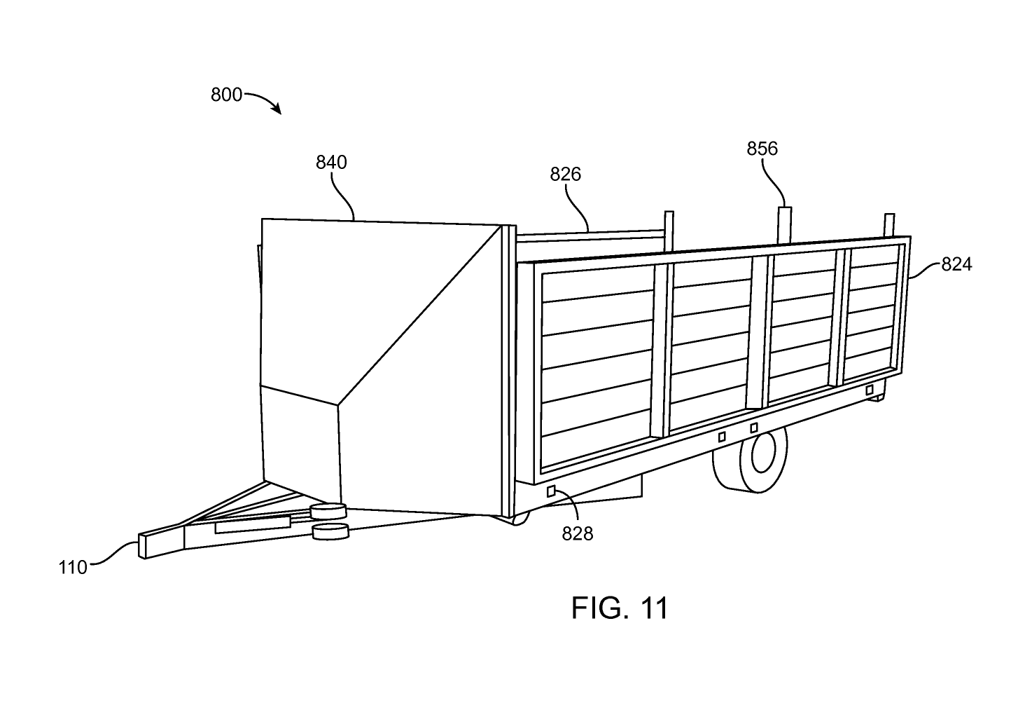

The portable platform 800 can include two platform segments 824, 826. The portable platform 800 can include two platform segments 824, 826, with each platform segment being pivotally, hingedly or otherwise coupled with the base segment 822. The portable platform 300 can also include a plurality of detachably coupled or rotatably actuated leveling supports 804 configured to contact the ground and support the base segment 822 when in the deployed configuration. The base segment 822 also includes a plurality of mounting brackets 828 disposed on a lengthwise edge of the base segment 822 (See FIGS. 10-11). A support arm 829 can be coupled with each of the mounting brackets 828 to support platform segment 824, 826 respectively when in the deployed configuration.

As can be appreciated in FIGS. 8 and 9, platform segment 824 can have two segments 8241, 8242 each capable of being independently pivoted relative to the base segment 822. Platform segment 826 can also have two segments 8261, 8262 each capable of being independent pivoted relative to the base segment 822.

The portable platform 800 can include a plurality of posts 810 for supporting a cover 815. In at least one embodiment, the portable platform 800 includes one post 810 secured substantially at each corner the portable platform by a mounting point 805 respectively. The portable platform 800 can have a plurality of seating units 830 disposed about the periphery of the platform segments 824, 826. Each of the plurality of seating units 830 can be configured to reside vertically within the platform segments 824,826 in a stored configuration and be actuated to a use configuration as illustrated in FIGS. 8-9. Each of the plurality of seating units 830 can be configured to support the weight of one or more adults. In at least one embodiment, each of the plurality of seating units 830 can support 500 pounds. In other embodiments, each of the plurality of seating units 830 can support between 300 and 1000 pounds.

The portable platform can include a television 840, coupled with or mounted on one or both of the base segment 822 and the trailer 102. The portable platform can include a grill 850 coupled with the base segment 822 on an end of the base segment opposite that of the television 840. The grill can include a bracket 852. The bracket can be used to couple the grill 850 with a grill post 854. The grill 854 post is secured to the base segment by a mounting point 856. The base segment 822 can also have a plurality of lids 860. Each of the plurality of lids 860 can be opened for access to a corresponding area 862. One or more the areas 862 can be any one of wet, dry, or temperature controlled storage. Alternatively, one or more areas 862 can serve as access to an inner portion of the portable platform 800 for maintenance or repair purposes. Alternatively, one or more areas 862 can serve as access to seating surfaces stowably formed into the surface of the base segment 822.

FIG. 10 is an isometric view of a fifth example embodiment of a portable platform in an undeployed configuration. FIG. 11 is an isometric view of the fifth example embodiment of a portable platform in a deployed configuration, viewed from another perspective. As shown, platform segments 824, 826 have been actuated such that they are perpendicular to the base segment 822 in the undeployed configuration. The platforms 824, 826 can be secured in the undeployed configuration by any means known to one of ordinary skill in the art.

The embodiments shown and described above are only examples. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size and arrangement of the parts within the principles of the present disclosure to the full extent indicated by the broad general meaning of the terms used in the attached claims. It will therefore be appreciated that the embodiments described above may be modified within the scope of the appended claims.

What is claimed is:

1. A portable platform comprising:
a trailer having a frame, an undercarriage, a plurality of wheels attached to the undercarriage, and a hitch;
a platform attached to the frame comprising:
a base segment attached to a top surface of the frame;
a plurality of platform segments pivotably coupled with the base segment,
wherein the plurality of platform segments are configured to pivotably rotate to be in substantially the same plane as the base segment when in use, and pivotably rotate substantially on top of the base segment when in storage thereby decreasing the total exposed surface area.

2. The portable platform of claim 1 further comprising a plurality of telescoping supports configured to expand and retract along the width of the platform.

3. The portable platform of claim 1 further comprising a plurality of leveling supports detachably coupled with a bottom side of the platform.

4. The portable platform of claim 1 wherein the hitch is configured to detachably couple the trailer with a vehicle.

5. The portable platform of claim 1 wherein the platform further comprises a stairwell pivotally attached along a rear edge of the base segment.

6. The portable platform of claim 1 further comprising at least one mounting point on the platform, each configured to support a post.

7. The portable platform of claim 6 wherein the post is configured to support a covering.

8. The portable platform of claim 7 wherein the covering is one of a canopy assembly, an umbrella assembly, and meshed netting.

9. The portable platform of claim 1 further comprising a trailer box mounted on the trailer wherein the trailer box includes a hinged top surface configured to be open and closed.

10. The portable platform of claim 1 wherein seating surfaces can be stowably formed into the surface of the base segment or the platform segments.

11. A portable platform comprising:
a trailer having a frame, an undercarriage, a plurality of wheels attached to the undercarriage, and a hitch;
a platform attached to the frame comprising:
a base segment attached to a top surface of the frame;
a plurality of platform segments slidably coupled with the base segment,
wherein the plurality of platform segments are configured to slide into substantially the same plane as the base segment when in use, and slide substantially on top of the base segment when in storage thereby decreasing the total exposed surface area.

12. The portable platform of claim 11 further comprising a plurality of telescoping supports configured to expand and retract along the width of the platform.

13. The portable platform of claim 11 further comprising a plurality of leveling supports detachably coupled with a bottom side of the platform.

14. The portable platform of claim 11 wherein the hitch is configured to detachably couple the trailer with a vehicle.

15. The portable platform of claim 11 wherein the platform further comprises a stairwell pivotally attached along a rear edge of the base segment.

16. The portable platform of claim 11 further comprising at least one mounting point on the platform, each configured to support a post.

17. The portable platform of claim 16 wherein the post is configured to support a covering.

18. The portable platform of claim 17 wherein the covering is one of a canopy assembly, an umbrella assembly, and meshed netting.

19. The portable platform of claim 11 further comprising a trailer box mounted on the trailer wherein the trailer box includes a hinged top surface configured to be open and closed.

20. The portable platform of claim 11 wherein seating surfaces can be stowably formed into the surface of the base segment or the platform segments.
